(19) United States
(12) Patent Application Publication
(10) Pub. No.: US 2012/0030607 A1
(43) Pub. Date: Feb. 2, 2012

(54) CONTROLLING A KEYBOARD

(76) Inventors: Alexandra Michel, San Francisco, CA (US); Leonard Tsai, Santa Clara, CA (US)

(21) Appl. No.: 13/260,321

(22) PCT Filed: Apr. 29, 2009
(86) PCT No.: PCT/US2009/042038

§ 371 Date: Sep. 25, 2011

(51) Int. Cl. G06F 3/048

(52) U.S. Cl. 715/773

(57) ABSTRACT

Devices, systems, methods, and other embodiments are associated with controlling a keyboard. In one embodiment, a remote control comprises an initiation button configured to cause a keyboard with keys to be displayed upon a remote display device. The remote control includes a keypad with a button set, where the button set maps with keys of a highlighted sector of the remote display device.

### COPYRIGHT NOTICE

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BACKGROUND

Typically, a television is packaged and sold with a dedicated remote control. The dedicated remote control allows a user to perform operations upon the television from the comfort of his or her chair. Example operations commonly incorporated in a remote control include volume adjustment, channel selection, and the like; these operations can be performed by pressing a button dedicated to a respective operation. Some buttons of the remote control, such as more generic buttons not dedicated to one operation, are arranged as a numeric keypad similar to one found on a conventional telephone. Buttons of the numeric keypad can perform different operations depending on a number of times a button is pressed within a set timeframe. For example, a ‘2’ button can input a ‘2’ if touched once, an ‘a’ if touched twice, a ‘b’ if touched three times, or a ‘c’ if touched four times. Therefore, numerous keystrokes are required to input information.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one embodiment of a system associated with a remote control and/or remote display device,

FIG. 2 illustrates one embodiment of a remote control associated with a remote display device.

FIG. 3 illustrates one embodiment of a remote control associated with a remote display device.

FIG. 4 illustrates one embodiment of a remote control associated with a remote display device,

FIG. 5 illustrates one embodiment of a remote display device associated with a remote control.

FIG. 6 illustrates one embodiment of a method associated with a remote control and/or remote display device.

FIG. 7 illustrates one embodiment of a method associated with a remote control and/or remote display device,

FIG. 8 illustrates one embodiment of a method associated with a remote control and/or remote display device.

### DETAILED DESCRIPTION

Disclosed herein are example systems, methods, and other embodiments associated controlling a keyboard. For example, the control can be with remote controls, remote display devices (e.g., televisions), and/or interaction between a remote control and a remote display device. In one embodiment, a keypad of a remote control comprises a keypad, such as a numbered keypad, that has a different number of buttons and configurations than keys of a QWERTY keyboard. A modified QWERTY keyboard displays upon the television and a portion of the keyboard is highlighted. The highlighted portion is equal in key number to a number of buttons of the keypad of the remote control and the highlighted portion is less than the entire keyboard. The buttons of the keypad can individually map in a one-to-one relationship with keys of the highlighted keyboard.

With an ability to change highlighted sections and directly map to a configuration of remote control buttons, a QWERTY keyboard can be used through a remote control keypad. Shifting of sections can allow a user to quickly type different characters while using one hand. Additionally, using a multi-tap method to enter text can be problematic since errors can occur if a button is tapped an incorrect number of times or a user waits too long in between taps. Allowing the user to switch between panes can increase likelihood that the correct key is inputted while eliminating problems of the multi-tap method.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

RAM: random access memory.

ROM: read only memory.

“Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more executable instruction that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

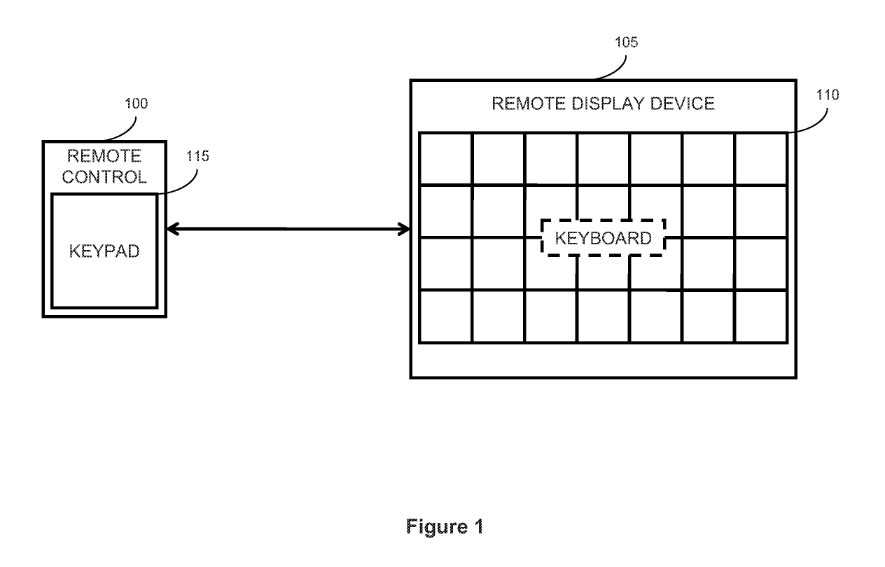

FIG. 1 illustrates one embodiment of a remote control 100 and a remote display device 105. A user can press a button of the remote control 100 that causes a keyboard 110 to display upon the remote display device 105. A portion of the keyboard 110 is highlighted and the highlighted section maps to buttons of a keypad 115 of the remote control 100. The user can change the highlighting through use of the keypad 115 and the newly highlighted section can map to the keypad 115. Therefore, the user can access keys of the keyboard with relatively few button presses and through use of the keypad 115.

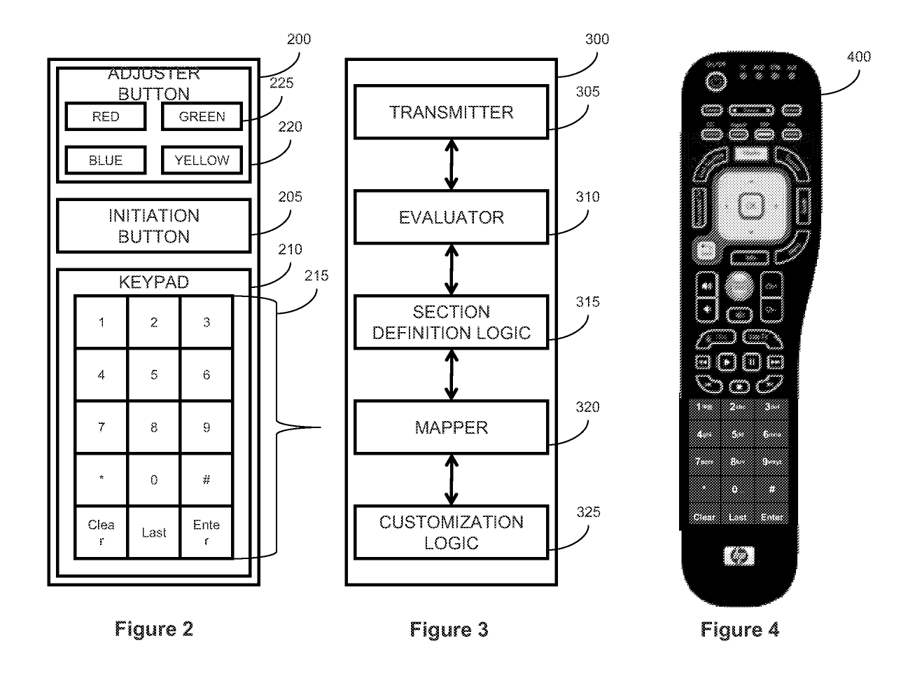

FIG. 2 illustrates one embodiment of a remote control 200 for controlling a remote display device (e.g., the remote display device 105 of FIG. 1). The remote control 200 includes an initiation button 205 that is configured to cause a keyboard (e.g., modified QWERTY keyboard) with keys to be displayed upon the remote display device. Additionally, the remote control 200 includes a keypad 210 with a button set 215 that can be configured as a numeric keypad (e.g., an array of buttons labeled 1, 2, 3, . . . similar to a keypad found on a telephone)

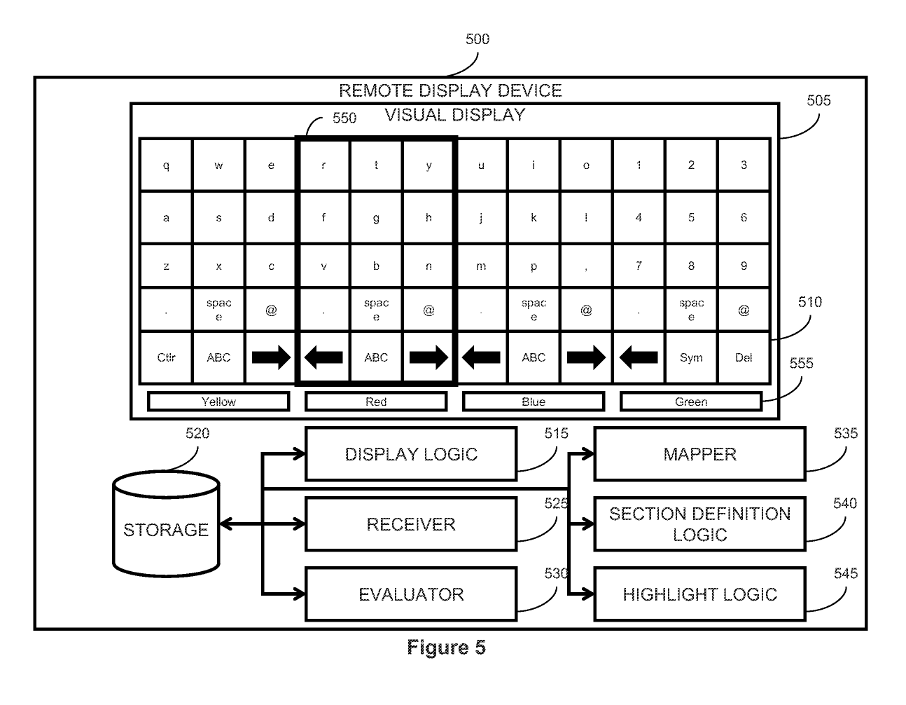

In this embodiment, the displayed keyboard is defined in multiple sectors where a sector size is determined based, at least in part, upon a size of the button set 215 For instance, if the keypad is in a three-by-five arrangement, then the sectors can be defined in three-by-five arrangements. One of the defined sectors is highlighted (e.g., visually highlighted and/or distinguished from the other sectors) and the button set 215 maps with keys of the highlighted sector of the remote display device in a one-to-one relationship. When a button of the button set 215 is pressed, an operation is performed designated by a displayed key mapped to the pressed button. For instance, if a user presses a button of the button set 215 designated as ‘1’, then a character of a key (e.g., a ‘r’ key) in the highlighted sector that maps to the ‘1’ button is inputted. A more detailed example of the displayed keyboard and highlighted sector will be described in FIG. 5.

According to one embodiment, the multiple sectors are distinct from one another (e.g., there is no overlap among keys). However, it is also possible for the multiple sectors to have some keys in common. The keys can also be arranged where multiple keys have identical functionality, such as multiple sectors having a key to shift the highlighted sector.

In one embodiment, the remote control 200 includes an adjuster button 220 that is configured to change the highlighted sector on the remote display device by engagement of the adjuster button 220 (e.g., when the adjustor button 220 is pressed). The button set re-maps with the highlighted sector of the displayed keys when the highlighted sector is changed by the adjustor button 220. It will be appreciated that the mapping function can be performed by either the remote control 200 or the remote display device. Using the previously mentioned instance where the ‘1’ button maps to the ‘r’ key, the ‘1’ button can be in an uppermost and leftmost button of the keypad and the ‘r’ key is the uppermost and leftmost key of the highlighted sector. The highlighted sector can change such that an ‘r’ key is the uppermost and leftmost key. Therefore, a re-map can occur so the ‘2’ button maps with the ‘r’ key. The remapping allows a user to select a greater number of keys with one hand than the number of buttons available with the button set 215 of the remote control 200.

According to another embodiment, the adjustor button 220 comprises a quick-move button (e.g., green quick-move button 225) configured to automatically switch the highlighted sector to a pre-defined sector of the displayed keyboard upon engagement. For instance, the adjustor button 220 can comprise four color based quick-move buttons: red, green, blue, and yellow. If the displayed keyboard is divided into four distinct sectors, one sector is assigned to each colored button. In one embodiment, a designator can be displayed above the keyboard sectors on the remote display device. The designator identifies a portion that is highlighted when the quick-move button is pressed. For example, a sector that is furthest right can have a green designator displayed above. When the green quick-move button is pressed, the highlighted sector moves to the sector denoted by the green designator.

In another embodiment, the adjustor button 220 is part of the button set 215 and at least one displayed key of the highlighted sector has an operation of switching sectors. The adjustor button 220 being part of the button set 215 can be in addition to the remote control 200 including at least one quick-move button. It is to be appreciated that buttons described herein include designated areas of a touch pad, a physical protrusion (e.g., made of plastic, made of foam, etc.) that activates an electrical circuit, and others. Therefore, a user can have access to a QWERTY keyboard from use of the remote control 200.

FIG. 3 illustrates one embodiment of a remote control 300 for controlling a remote display device with various functional aspects. It is to be appreciated that the remote control 200 of FIG. 2 and the remote control 300 can be the same remote control where FIG. 2 illustrates an example exterior and FIG. 3 illustrates example interior logic components. For example, a transmitter 305 can be included in the remote control 300 to transfer wireless signals to the remote display device. For example, when the initiation button 205 of FIG. 2 is pressed, the transmitter 305 can send a signal to the remote display device that a graphical keyboard should be displayed. The transmitter 305 can also function to collect signals, such as an instruction or request from the remote display device, and thus allow for greater communication between the remote control 300 and remote display device.

According to one embodiment, the remote control 300 assists with configuration and functioning of the displayed keyboard. For example, a section size of the keyboard can be based upon a size of a keypad of the remote control 300. An evaluator 310 is configured to analyze the keypad and section definition logic 315 determines, based upon a result of the analysis, what array should be used to segment the displayed keyboard (e.g., segment with an array that matches the keypad size). In one embodiment, the analysis can include reading a predetermined size value from memory. The transmitter 305 sends a notification to the remote display device on the determined array. The remote display device makes appropriate segmentation of the keyboard to create different portions capable of being highlighted. Since a highlighted portion is made to match the layout and button arrangement of the keypad, there is greater personalization for a remote control used by a user.

In a further embodiment, the remote control 300 assists in mapping buttons of the button set 215 of FIG. 2 with keys of a highlighted portion of the displayed keyboard. The mapping occurs with a physical matching of buttons with keys. For example, a button of the keypad in an upper right corner maps to a key in an upper right corner of a highlighted portion. Since use of the highlighted portion makes some keys unmapped, one of the mapped buttons can function to change the highlighted section to cover a different portion of keys. As such, the adjustor button 220 of FIG. 2 can be part of the button set 215 of FIG. 2. For a displayed keyboard with k pads, and using an adjustor button 220 of FIG. 2 that is part of a button set, a maximum input to reach a key of the keyboard is INT[½*k] button presses away. Therefore, keys of the displayed keyboard can be easily reached with minimal button presses.

In yet another embodiment, customization logic 315 allows a user to make modifications in order to personalize his or her remote control usage experience. In one example, a QWERTY keyboard can be initially displayed on the remote display device. However, as a user engages the keyboard, he or she may find that the QWERTY configured keyboard is not ideal (e.g., frequently engaged keys require a relatively large number of button presses among one another). Therefore, the customization logic 315 enables the user to make modifications to the displayed keyboard. The modifications can be applied to one usage session, to all usage sessions of a particular user, to all sessions, etc. Personalization can allow for even fewer button presses to enter text or perform a function.

FIG. 4 illustrates one embodiment of an exterior view of a remote control 400 for controlling a remote display device. The remote control 400 can incorporate other arrangements of buttons in other embodiments. For example, portions of the buttons of remote control 200 of FIG. 2 can be included and/or potions of the logic from remote control 300 of FIG. 3 can be included.

FIG. 5 illustrates one embodiment of a remote display device 500 controllable by a remote control. The remote display device 500 (e.g., a television) can include a visual display 505 that presents a keyboard 510 in graphical form. Display logic 515 can function to display at least part of the keyboard 510 with keys on the visual display 505. Storage 520 (e.g., a computer-readable medium) can retain information, such as a preferred format for displaying the keyboard 510.

In one embodiment, a receiver 525 obtains an instruction from a remote control to display the keyboard 510. An evaluator 530 analyzes the instruction to determine how display should occur. In one embodiment, the evaluator 530, mapper 535, and/or section definition logic 540 can be implemented similar to the same-named components of FIG. 3. The section definition logic 540 defines sections of the displayed keyboard 510 as a function of a configuration of buttons of a keypad of the remote control. Highlight logic 545 highlights one of the defined sections of the displayed keyboard 510. Using the button configuration of the keypad in highlighting allows a user to easily reach various displayed keyboard keys.

With the remote visual display 500, highlight logic 545 highlights a section 550 (e.g., a bolded section 550 in FIG. 5) of the displayed keyboard 510. Additionally, the mapper 510 maps highlighted displayed keys of the highlighted section 550 with buttons of a keypad of a remote control in a one-to-one relationship. The receiver 515 is configured to collect signals from the remote control. Received signals are interpreted to identify a notification to perform an operation. For example, the notification can be based upon a user pressing a button of the remote control that maps to the highlighted key. By pressing a button of the remote keypad, a character is caused to be placed on an Internet browser, change highlighted sections, and so on.

According to one embodiment, suppose the receiver 515 collects a notification signal to change the highlighted section 550 (e.g., from a user pressing a quick-move button associated with a designator 555). The highlight logic 545 then changes the highlighted section 550 based on the notification (e.g., a change designated by the user). It is possible for the keys in a highlighted sector before the change and the keys in a highlighted sector after the change to share at least one key in common.

In another embodiment, the displayed keyboard can be defined such that a portion less than the entire keyboard is displayed on the visual display 505. The highlighted section 550 of the displayed keyboard 510 can be the entire displayed portion or less. Additionally, changing the highlighted section can made to remove at least some of the keys from the visual display 550 as well as add at least some keys to the visual display 505.

In FIG. 5, the visual display 505 displays the entire keyboard. The highlighted section 550 is defined to match the size and/or arrangement of the keypad from the remote control, which is less than the entire keyboard. Additionally, a current highlighted sector (e.g. before the highlight is moved) and a highlighted sector after being moved/changed can be distinct from one another (e.g. they do not overlap). Therefore, the remote render device 500 can assist a user to quickly navigate a full keyboard using a small remote keypad and type letter selections in a convenient manner using fewer keystrokes.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

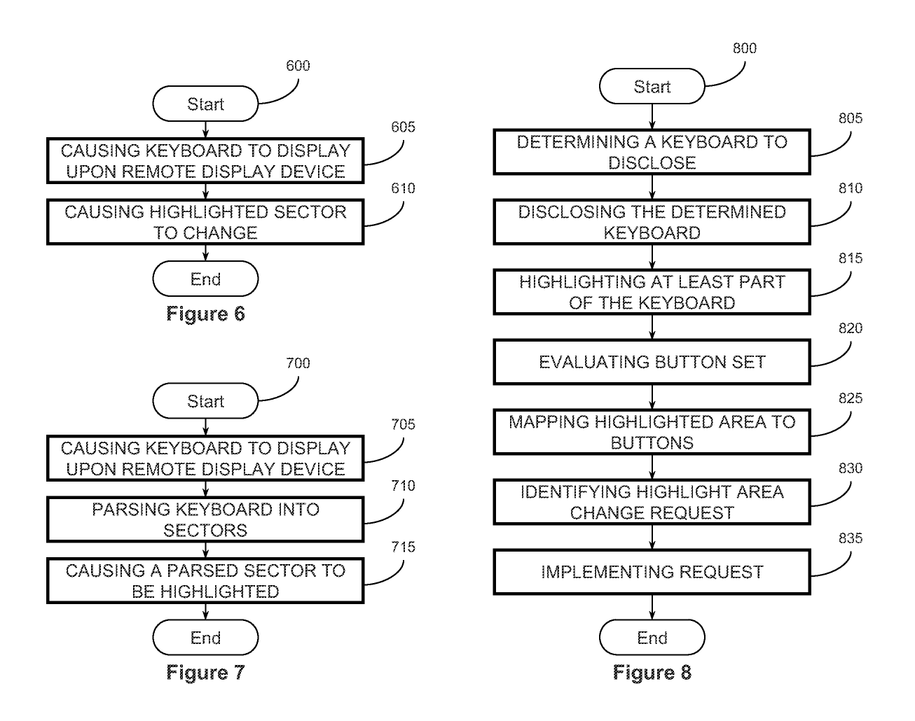

FIG. 6 illustrates an embodiment of a methodology 600 (e.g., operable upon a remote control) for causing operations in relation to a keyboard (e.g., a keyboard displayed upon a remote display device). At block 605, the method can initiate by causing a graphical keyboard with keys to display upon the remote display device. For instance, when a user presses an initiation button of the remote control, the initiation button can send an instruction to the remote display device to display the keyboard. The graphical keyboard is defined with multiple sectors and one of the sectors is highlighted when display occurs. Additionally, displayed keys of the highlighted sector are mapped to a group of buttons of the remote control in a one-to-one relationship. With the keyboard displayed and keys mapped to a highlighted section of the displayed keyboard, a user can easily understand how buttons of the remote control are used in accordance with the displayed keyboard.

At block 610, the method includes causing the highlighted sector to change, such as from the user pressing an adjuster button of the remote control. Keys of the changed highlighted sector are then mapped (e.g., automatically) to the group of buttons of the remote control in a one-to-one relationship. Allowing the highlighted sector to change enables the user to access other parts of the displayed keyboard from his or her remote control.

According to one embodiment, causing the highlighted sector to change includes switching from a currently highlighted sector to a different sector of the keyboard. After the switch, the different sector becomes the highlighted sector. The highlighted sector before the change and the highlighted sector after the change can share at least one displayed key (e.g., there is overlap such that at least one key is covered by the two sectors). However, it is also possible for changed sections to be distinct from one another.

According to another embodiment, causing the highlighted sector to change occurs in response to signal from a hard-coded button (e.g., a quick-move button) of a remote control. The hard-coded button is, for example, configured to shift the highlighted sector to the next adjacent sector defined in the displayed keyboard each time the hard-coded button is pressed by a user. In another embodiment, the hard-coded button can be customizable to define a sector highlighted when the hard-coded button is pressed. In an alternative embodiment, causing the highlighted sector to change occurs in response to designation of a button mapped with the pre-changed highlighted sector. Changing sectors can minimize an overall amount of button presses for the user to enter text and navigate the displayed keyboard.

FIG. 7 illustrates an embodiment of a methodology 700 for managing a displayed keyboard. Block 705 can share functionality of block 605 such that a keyboard is caused to display. The displayed keyboard is parsed into different sectors (e.g., key groups of more than one key) at block 710. The sectors can be based upon remote control keypad size and be areas upon which highlighting occurs. Of course, the parsing and definition of key groups can be predetermined). In an alternative embodiment, parsing does not occur and highlighting is moved on a line-by-line or key-by-key basis.

Returning to the methodology 700, once the keyboard is parsed, one of the parsed sections is highlighted at block 715. Using parsing in conjunction with keypad size allows for a user to access many keys from one keypad.

FIG. 8 illustrates an embodiment of a methodology 800 for operating a displayed keyboard upon a remote display device. The methodology 800 can be operable upon a remote display device, as well as a remote control and others. A determination is made at block 805 to disclose a graphical keyboard and the keyboard is disclosed at block 810 (e.g. display on a screen). For instance, a request to display can be collected and evaluated to determine if the request is authorized (e.g., from an authorized remote control). If the request is authorized, then display occurs.

In one example, if there are two nearby remote controls and remote display devices, then it is possible for signals from both remote controls to be collected by one remote display device. Checking if a request is authorized can minimize an amount of incorrect actions based upon signals being collected that are not intended for a particular remote display device,

At block 815 at least part of the keyboard is highlighted in accordance with aspects previously discussed. A button set of the remote control is evaluated at block 820 and based upon the evaluation; the button set is mapped with the highlighted area at block 825. A user can request to change the highlighted part of the displayed keyboard. The request can be identified at block 830 and implemented at block 835. Implementing the request can include identifying what the request is (e.g., what part the user wants highlighted) and changing the highlighted part in accordance with the request. Changing the highlighted section in response to a user request gives the user a high level of control over the displayed keyboard from his or her remote control.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended dams.

To the extent that the term “includes” or “including” is employed in the detailed description or the claims, it is intended to be inclusive in a manner similar to the term “comprising” as that term is interpreted when employed as a transitional word in a claim.

1. A remote control, comprising:
an initiation button configured to cause a keyboard with keys to be displayed upon a remote display device, where the keyboard is defined in multiple sectors and where one of the sectors is highlighted;
a keypad with a button set, where the button set maps with keys of the highlighted sector of the remote display device in a one-to-one relationship and where when a button of the button set is pressed, an operation is performed designated by a displayed key mapped to the pressed button; and
an adjuster button configured to change the highlighted sector on the remote display device by engagement of the adjuster button, where the button set re-maps with the highlighted sector of the displayed keys when the highlighted sector changes.

2. The remote control of claim 1, where the adjustor button comprises a quick-move button configured to automatically switch the highlighted sector to a pre-defined sector of the displayed keyboard upon engagement.

3. The remote control of claim 2, where at least one designator appears on the remote display device, the at least one designator identifies a portion that is highlighted when the quick-move button is pressed.

4. The remote control according to claim 1 where the adjustor button is part of the button set and at least one displayed key of the highlighted sector has an operation of switching sectors.

5. The remote control according to claim 1 or 4, where the multiple sectors are distinct from one another.

6. A method operable upon a remote control, comprising:
causing a graphical keyboard with keys to display upon a remote display device, where the graphical keyboard is defined with multiple sectors, where one of the sectors is highlighted when display occurs, and where displayed keys of the highlighted sector map to a group of buttons of the remote control in a one-to-one relationship; and
causing the highlighted sector to change, where keys of the changed highlighted sector map to the group of buttons of the remote control in a one-to-one relationship.

7. The method of claim 6, where causing the highlighted sector to change includes switching between a highlighted sector before the change and a highlighted sector after the change, where the highlighted sector before the change and the highlighted sector after the change share at least one displayed key.

8. The method according to claim 6, where causing the highlighted sector to change occurs in response to designation of a hard-coded button and where the hard-coded button does not change functionality when the highlighted sector changes.

9. The method according to claim 6 where causing the highlighted sector to change occurs in response to designation of a button mapped with the pre-changed highlighted sector.

10. A system, comprising:
means for displaying at least part of a keyboard with keys on a visual display;
means for highlighting a section of the displayed keyboard;
means for mapping highlighted displayed keys with buttons of a keypad of a remote control in a one-to-one relationship; and
means for collecting a notification to perform an operation, where the operation correlates to a highlighted key and the notification is based upon a user pressing a button of the remote control that maps to the highlighted key.

11. The system of claim 10, further comprising:
means for collecting a notification to change the highlighted section; and
means for changing the highlighted section in accordance with the user designation.

12. The system of claim 11, where keys of a highlighted sector before the change and keys of a highlighted sector after the change share at least one key in common.

13. The system according to claim 11 where a part less than the whole of the keyboard is displayed on the visual display, where the highlighted section of the displayed keyboard is the entire displayed portion, and where the change of the highlighted section causes removal of at least some of the keys from the visual display and addition of at least some keys to the visual display.

14. The system according to claim 11 where the visual display displays the entire keyboard, where the highlighted section is less and the entire keyboard, and where a highlighted sector before the change and a highlighted sector after the change are distinct from one another.

15. The system according to claim 10 further comprising means for defining sections of the displayed keyboard as a function of a configuration of the buttons of the keypad of the remote control, where means for highlighting highlights one of the defined sections of the displayed keyboard.
